(19) United States
(12) Patent Application Publication
(10) Pub. No.: US 2014/0256486 A1
(43) Pub. Date: Sep. 11, 2014

(54) TENSIONING DEVICE WITH SPRING DIAPHRAGM

(71) Applicant: IWIS MOTORSYSTEME GMBH & CO., KG, Munchen (DE)

(72) Inventors: Christoph LUNK, Munchen (DE); Renzo PERISSINOTTO, Dachau (DE); Christian SCHOLDERLE, Gilching (DE)

(21) Appl. No.: 14/194,487

(22) Filed: Feb. 28, 2014

(30) Foreign Application Priority Data
Mar. 5, 2013 (DE) 102013004850.8

(51) Int. Cl. F16H 7/08

(52) U.S. Cl. CPC F16H 7/08
USPC 474/110

(57) ABSTRACT

A tensioning device, in particular for a highly dynamic endless drive, such as a chain drive or a belt drive for an internal combustion engine, comprises a tensioner housing, a tensioning piston displaceably arranged in the tensioner housing, a pressure chamber formed between the tensioner housing and the tensioning piston and a pressure medium inlet leading into the pressure chamber and including a non-return valve. In order to meet also new demands, in the case of which oil pumps with having a low feed pressure are used, the present device discloses that a valve body of the non-return valve is defined by a leaf spring diaphragm. The device additionally relates to a non-return valve as well as an endless drive.

### CROSS-REFERENCE TO RELATED APPLICATION

This application claims priority to foreign German patent application No. DE 102013004850.8, filed on Mar. 5, 2013, the disclosure of which is incorporated by reference in its entirety.

### FIELD OF THE INVENTION

The present invention relates to a tensioning device, in particular for a highly dynamic endless drive, such as a chain drive or a belt drive for an internal combustion engine, comprising a tensioner housing, a tensioning piston displaceably arranged in the tensioner housing, a pressure chamber formed between the tensioner housing and the tensioning piston and a pressure medium inlet leading into the pressure chamber and including a non-return valve, a valve body of the non-return valve being defined by a spring diaphragm.

### BACKGROUND

Such tensioning devices are used e.g. for timing chain drives on an internal combustion engine and they normally press a pivotably arranged tensioner blade with its slide surface against a timing chain. The tensioning device is normally connected to the engine oil hydraulic system of the internal combustion engine and has hydraulic fluid supplied thereto via a pressure medium inlet. In many cases a helical compression spring and a filler body for reducing the filling volume of the pressure chamber are additionally provided within the pressure chamber between the tensioning piston and the tensioner housing. Due to the fast running endless drive, the tensioning device is subjected to substantial highly dynamic loads that necessitate a fast switching non-return valve which operates efficiently throughout its service life. The valves used are mainly ball check valves in which a helical compression spring presses a valve body configured as a ball into an opening position so that hydraulic fluid can flow via the pressure medium inlet and the non-return valve into the pressure chamber. However, as soon as the pressure in the pressure chamber exceeds a certain limit, the non-return valve will close. Hydraulic fluid can then escape from the pressure chamber only via possibly existing leakage paths, which determine the damping characteristics of the tensioning device. In addition, also plate or disk-shaped valve bodies are known for such cases of use. In modern internal combustion engines controlled oil pumps are increasingly used. These oil pumps control the supply pressure so as to achieve low specific consumption. This means that hydraulic chain tensioners must be capable of operating even if the supply pressure should be low.

A tensioning device of the type in question is known from DE 11200603102 T5. Other examples of spring diaphragms are described in DE 4030717 A1, DE 102006055466 A1 and EP 0473261 A2. In contrast to the conventional translational movement of a rigid valve body, the spring and the valve body form here a unit and execute a movement after the fashion of a cantilevered bending beam. Configuring the valve body and the spring in common as a spring diaphragm offers the possibility of establishing a closure system with much smaller masses, which has a comparatively soft spring characteristic and ensures nevertheless a fast and reliable opening and closing of the non-return valve. The use of the spring diaphragm therefore allows the provision of large inflow cross-sections in combination with small moving masses as well as low opening pressures.

### SUMMARY OF THE INVENTION

It is therefore the object of the present invention to provide a tensioning device which remains capable of operating even if the supply pressures should be low and which is nevertheless robust as well as cost-efficient.

According to the present invention, this object is achieved by a tensioning device of the above-mentioned type according to claim 1. The spring diaphragm comprises here a holding area, which is arranged such that it is at least secured against rotation preferably relative to the tensioner housing, and two elastically arranged closure areas extending away from said holding area and covering each a respective inlet opening in the closed condition. This allows a plurality of design possibilities, which also influence the mass to be moved and the spring rate accomplished.

In addition, a reception bore with a concave inner surface is provided, the inlet openings terminating at the concave inner surface, and the closure areas of the spring diaphragm having a curved shape, which is adapted to the reception bore, and abutting on the concave inner surface of the reception bore in the closed condition. Up to now, the flow into the pressure chamber often took place coaxially with the tensioning-piston axis, so that the valve body also moved along this direction. Therefore, the inlet opening was normally arranged in a flat surface at the bottom of the tensioner housing or valve housing and was sometimes provided with an edge that was chamfered or adapted to the shape of the valve body. In contrast to this, the spring diaphragm is here in close contact with a concave inner surface of the reception bore and has a shape that is adapted thereto. This also provides the possibility of elegantly positioning such a spring diaphragm in the reception bore. For example, the holding area may be retained in the reception bore simply by form-fit engagement therewith. Normally, the spring diaphragm is, however, installed in the reception bore under a certain pretension or it is press-fitted therein. The reception bore may be arranged especially in the tensioner housing or in a valve housing.

By using two inlet openings, the flow cross-section can be enlarged, the spring diaphragm having then preferably a symmetric structural design. For accomplishing a desired incoming flow also the contour of the closure areas may be adapted accordingly.

In order to avoid excessive loads on the spring diaphragm, a substantially central stop means is provided, which limits the opening stroke of the closure areas. The closure areas can therefore only execute a limited stroke and are then prevented from still further by the stop means. If the spring diaphragm has a symmetric structural design, the stop means is configured such that, when the inlet opening is being opened, the closure areas first move towards one another and prevent one another then from executing any further movements.

To this end, the reception bore is preferably cylindrical in shape and the closure area has a curved shape adapted thereto. Depending on the respective structural design, the closure area can therefore move into close, large-area contact with the inner wall of the reception bore and thus efficiently seal the inlet opening.

According to a further embodiment, the use of a spring diaphragm also offers the possibility of defining the inlet openings and/or the reception bore by the tensioner housing and installing the spring diaphragm directly in said tensioner housing. It is therefore not absolutely necessary to provide a separate valve housing, whereby a reduction of costs can be achieved.

Nevertheless, the non-return valve may include a valve housing having the spring diaphragm arranged therein according to another embodiment, said valve housing being arranged in the pressure medium inlet of the tensioning device. The use of a valve housing can simplify the mounting of the non-return valve in the tensioner housing. This variant will be particularly suitable in the event that these components are produced separately and assembled subsequently. In some cases, it may, however, also be possible to produce the inlet openings more accurately in a valve housing, in particular in the area of the reception bore. The reason for this is that the sectional edges of a reception bore and an inlet opening in a valve housing are not positioned as deeply in a blind hole bore as in the case of a tensioner housing.

In addition, anti-loss and/or rotation-lock means retaining the spring diaphragm in its position may be provided. In order to allow the spring diaphragm and its components to be easily positioned relative to the inlet openings, adequate means which facilitate mounting are provided. These means may e.g. be projections or recesses, such as grooves etc., on the spring diaphragm or on the tensioner housing or valve housing.

Preferably, the spring diaphragm may be produced from a stamp-bending part, preferably a spring steel sheet. Embodiments making use of a single sheet-metal blank, so that weak spots originating from additional connections can be avoided, are here particularly advantageous.

According to a preferred further embodiment, the spring diaphragm is made of plastic material. Materials suitable for this purpose are well-established heavy duty plastics, which may also be fiber reinforced in some cases. In particular the use of an overload protection, e.g. in the form of a stop means, will, however, allow the use of other materials as well.

Especially in the case of a variant using plastic materials, it will be of advantage, when, starting from the holding area, the thickness of the closure area decreases substantially continuously towards the free end of the closure area. It is thus possible to accomplish a sufficiently high strength in the actual load area and a soft spring characteristic, so that a spring diaphragm with a high number of strokes will obtain a long service life.

In addition, the closure surface of a closure area may have formed therein a flow directing contour in the form a depression extending beyond the opening cross-section of the inlet opening. Depending on the respective structural design, the closure areas of the spring diaphragm abut in large-area sealing contact. For guaranteeing reliable flowing-off also in the case of small opening strokes, this flow directing contour, which provides a larger flow-off cross-section even in the case of small opening strokes, may be used. The effect of this kind of measure will also be advantageously enhanced, when the thickness of the closure area decreases towards the free end.

Furthermore, the present invention relates to a non-return valve for a tensioning device according to one of the claims 1 to 9. The non-return valve is characterized in that a valve body of the non-return valve is defined by a spring diaphragm. Especially in the sphere of endless drives, in particular timing drives of an internal combustion engine, ball and plate valves have mainly been used up to now. The reason for this is that these valves generally exhibit a high degree of reliability when used in highly dynamic processes. However, they partially fail to satisfy the demands entailed by new internal combustion engine concepts.

In addition, the present invention also relates to an endless drive, in particular timing drive of an internal combustion engine, comprising a drive pulley, a driven pulley, an endless drive means coupling said drive pulley and said driven pulley, and a tensioning device according to one of the claims 1 to 9 for tensioning the endless drive means. In a timing drive of an internal combustion engine, the drive pulley may be a crankshaft wheel, in particular a crankshaft sprocket, and the at least one driven pulley may be a camshaft wheel, in particular a camshaft sprocket. The tensioning device is then normally a chain tensioner that is connected to the engine oil hydraulic system and applies pressure to a tensioner blade, which, in turn, abuts on a timing chain. The timing chain may have a great variety of different structural designs, such as a sleeve-type chain, a roller chain and a toothed chain. In addition to the timing drive, also auxiliary drives of an internal combustion engine may be provided with such a tensioning device. The material used for the chains is normally steel.

### BRIEF DESCRIPTION OF THE DRAWINGS

In the following, embodiments of the present invention will now be explained in more detail making reference to drawings, in which:

FIG. 1 shows a schematic front view of a timing chain drive,

FIG. 2 shows a first embodiment of a chain tensioner in a full section view,

FIG. 3 shows the non-return valve according to FIG. 2 in a perspective representation,

FIG. 4 shows the non-return valve according to FIG. 3, the valve housing being shown in a full section view,

FIG. 5 shows the valve diaphragm according to FIG. 4 in a perspective front view,

FIG. 6 shows the valve diaphragm according to FIG. 5 in a side view,

FIG. 7 shows the valve diaphragm according to FIG. 5 in a top view,

FIG. 8 shows a second embodiment of a valve diaphragm in a perspective view,

FIG. 9 shows a second embodiment of a non-return valve with the valve diaphragm according to FIG. 8, the valve housing being shown in a full section view,

FIG. 10 shows a fragmentary view of a further embodiment of the chain tensioner with a valve diaphragm according to FIG. 8, the chain tensioner housing being shown in a full section view, and

FIG. 11 shows a further embodiment of a non-return valve in a schematic sectional top view.

### DETAILED DESCRIPTION

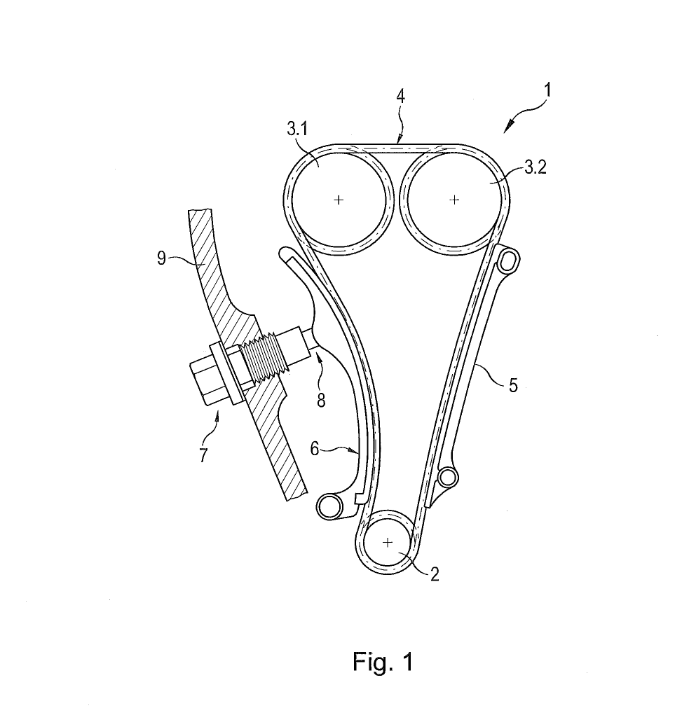

The timing chain drive 1 for an internal combustion engine shown in FIG. 1 essentially comprises a crankshaft sprocket 2, two juxtaposed camshaft sprockets 3.1 and 3.2, a timing chain 4 wrapped around these sprockets, a chain guide 5 fixed to the engine block, a tensioner blade 6 pivotably arranged on the engine block and a chain tensioner 7 whose tensioning piston 8 presses against the tensioner blade 6. In the present case, the chain tensioner 7 is configured as a so-called screw-in chain tensioner, which is screwed into a wall 9 on the engine case. The chain tensioner 7 may, however, also be configured as a flange- or attachment-type chain tensioner. The crankshaft sprocket 2 drives the two camshaft sprockets 3.1 and 3.2 by means of the timing chain 4. In the course of this process, the tight span of the chain 4 slides along the chain guide 5 and the slack span slides along the tensioner blade 6. The chain tensioner 7 must apply a sufficiently strong force to the tensioner blade 6 so that reliable tensioning of the timing chain 4 will be guaranteed over the whole operating range of the internal combustion engine. Highly dynamic processes will here take place in the interior of the chain tensioner 7, which also provides a damping function.

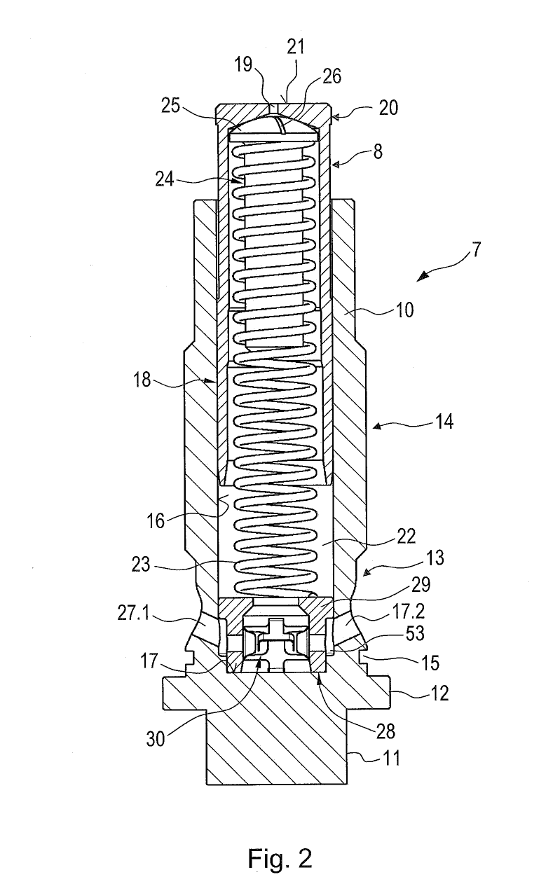

In the following, a more detailed structural design of a chain tensioner embodiment will be explained more precisely with the aid of FIG. 2.

The chain tensioner 7, which is shown in a full section view in FIG. 2, comprises a screw-in housing 10 with a hexagon head 11 and an abutment flange 12, a supply portion 13 and a threaded portion 14. The abutment flange 12 and the supply portion 13 have provided between them an annular groove 15 for arranging therein a sealing ring so as to seal the supply portion 13 from its surroundings. The tensioner housing, which is substantially cylindrical in the front area thereof, has a guide bore 16 configured as a blind bore with a bottom surface 17. The guide bore 16 serves to receive the tensioning piston 8 therein and to guide it in a longitudinally displaceable manner, the guided portion 18 of said tensioning piston 8 being guided in the reception bore such that a leakage gap is defined. The tensioning piston 8 has a head 20, which, except for a vent hole 19, is closed and which includes a pressing surface 21 that presses against the tensioner blade 6. A pressure chamber 22 is formed between the tensioner housing 10 and the tensioning piston 8, said pressure chamber 22 extending partially into the interior of the substantially hollow tensioning piston 8. In addition, the pressure chamber 22 has arranged therein a helical compression spring 23 and a mushroom-shaped filling element 24 reducing, on the one hand, the filling volume of the pressure chamber 22 and comprising, on the other hand, a vent groove 26 on its head 25, which is in flow communication with the vent hole 19. In the supply portion 13 two diametrically arranged supply bores 27.1 and 27.2 are provided, which extend at an oblique angle downwards and which establish a connection to the reception bore 16. At the bottom of the reception bore 16, a non-return valve 28 is installed, which comprises a valve housing 29 and a valve diaphragm 30.

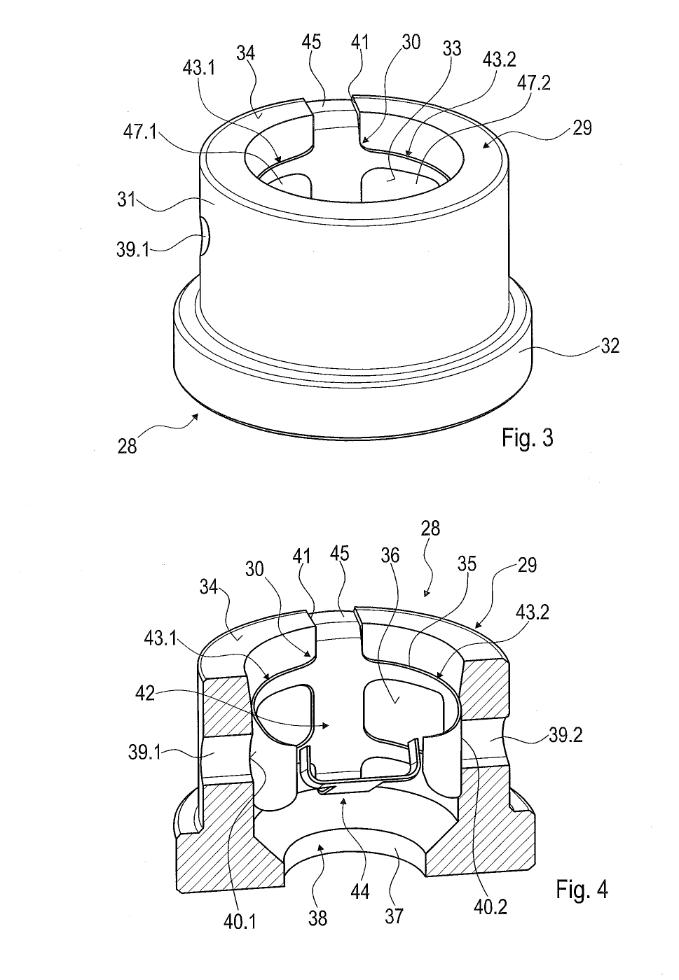

Making reference to FIGS. 3 to 7, the structural design of this non-return valve 28 will now be explained in more detail. The valve housing 29 comprises a first cylindrical portion 31 and a second cylindrical portion 32, which is configured in a flange-like manner. The diameter of the first cylindrical portion 3 is therefore smaller than that of the second cylindrical portion 32. The valve housing 29 has provided therein an axial reception bore 33, which is configured conically after the fashion of an insertion aid in its area 35 facing the first end face 34. This area 35 is followed by a cylindrical central area 36 merging with a further conically tapering area 37, which, in turn, ends in a cylindrical outlet bore 38. Two inlet bores 39.1 and 39.2, which are arranged diametrically in the first cylindrical portion, end in the central area 36 of the reception bore 33, said inlet bores 39.1 and 39.2 forming two respective inlet openings 40.1 and 40.2 on the central area 36. In addition, the valve housing 29 includes a reception groove 41 on the end face 34 as well as on the outer circumferential surface of the first cylindrical portion 31, said reception groove 41 being displaced by substantially 90° relative to the inlet bores 39. The valve housing 29 is preferably made of a steel material, it may, however, also consist of some other metal or of plastic material.

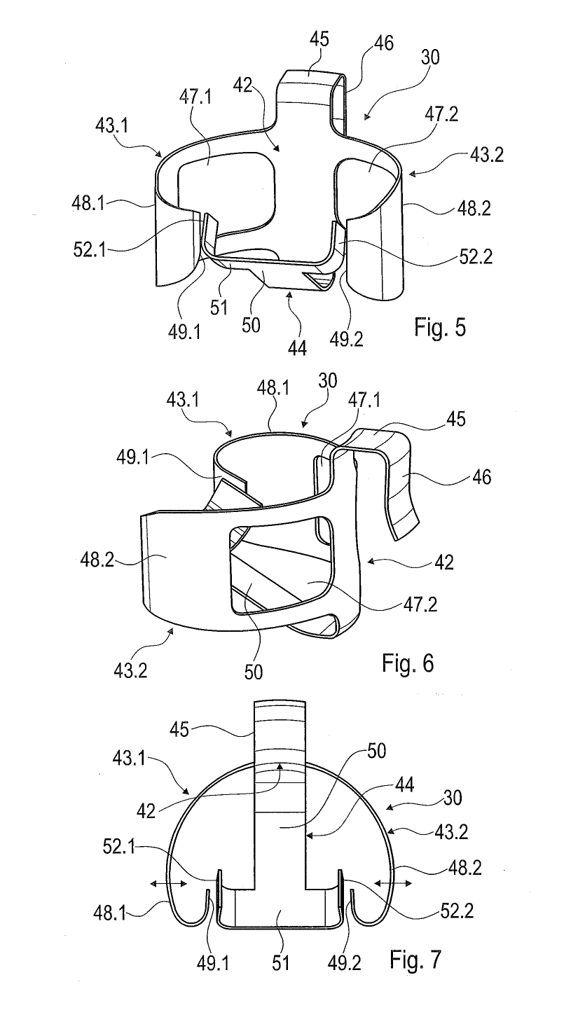

The reception bore 33 has now inserted therein the valve diaphragm 30, which is separately shown in FIGS. 5 to 7. The valve diaphragm 30 is formed from a sheet metal blank, preferably from a spring steel, by means of a stamp-bending process. The valve diaphragm 30 is formed such that a great variety of different functions is provided simultaneously. The main components of the valve diaphragm 30 are, on the one hand, the centrally arranged holding area 42 and the closure areas 43.1 and 43.2 provided thereon in a wing-like manner. On the other hand, the lower end of the holding area 42 has additionally formed thereon a stop means 44. The holding area 42 is substantially formed by a straight, centrally arranged sheet metal strip, which projects beyond the closure areas 43 at its upper end and which is bent back in a U-shape after the fashion of a locking clip. The U-web 45 and the free U-leg 46 come to lie in the retaining groove 41 when the valve diaphragm 30 is arranged in the valve housing 29, so that an anti-loss and rotation-lock arrangement is defined. The depth of the retaining groove 41 is slightly larger than the sheet metal thickness of the valve diaphragm 30. The free U-leg 46 is slightly bent inwards and has on its end a portion which, in turn, is slightly bent outwards as an insertion aid, so that the free U-leg 46 acts as a spring arm.

The closure areas 43.1 in 43.2 extend like wings laterally away from the central holding area 42. The rear portions, which directly adjoin the holding area 42, each include a window 47.1 and 47.2, so that only an upper and a lower sheet metal strip remain. The windows 47.1 and 47.2 have rounded corners, and the corners located closer to the holding area 42 have a larger radius. The windows essentially influence the spring characteristics of the closure areas 43.1 and 43.2, so that their size is chosen in accordance with the desired spring characteristics. The front portions of the closure areas 43.1 and 43.2 are configured as full-area contact portions 48.1 and 48.2. These contact portions 48.1 and 48.2 are closure elements covering, i.e. closing the actual inlet openings 40.1 and 40.2 in the valve housing 29. The area of the contact portions 48.1 and 48.2 is therefore larger than the cross-sectional area of the inlet openings 40.1 and 40.2. The closure areas 43.1 and 43.2 are arcuate in shape with a curvature, so that, after having been inserted in the valve housing 29, they will be in close contact with the concave inner wall of the reception bore 33. Insertion into the reception bore 33 can take place under slight pretension, so that the closure areas 43.1 and 43.2 are bent open a bit wider in the non-mounted condition and are then inserted into the reception bore 33 under pretension. The respective free ends of the closure areas 43.1 and 43.2 have formed thereon end portions, which are bent back in a U-shape and the free U-legs 49.1 and 49.2 of which serve as a contact surface.

The stop means 44 is, when seen in a top view (FIG. 7), approximately T-shaped. Its central leg 50 is arranged on the lower end of the holding area 42 and extends then, after a certain distance, at an oblique angle upwards, so that the stop means 44 reaches the area of the free ends of the closure areas 43. The free ends of the front crosspiece 51 of the stop means 44, which adjoins the leg 50, are bent substantially perpendicularly towards the interior of the valve diaphragm 30, so that a respective stop lug 52.1, 52.2 is formed on either side. In the installed condition of the valve diaphragm 30, the stop lug 52.1 is spaced at a predetermined distance from the stop surface of the free U-leg 49.1, said predetermined distance defining the opening stroke to the associated closure area 43.1. This applies in the same way to the opposite side with the stop lug 52.2 and the stop surface of the free U-leg 49.2. As can be seen from FIG. 2, the non-return valve 28 shown in FIG. 3 is installed upside down in the valve housing, so that the end face 34 abuts on the bottom surface 17 of the tensioner housing 10 and the helical compression spring 23 presses against the opposed end face of the valve housing 29. Hence, also the U-web 45 of the holding area 42 is located between the bottom surface 17 and the retaining groove 41. This measure has the effect that the valve diaphragm 30 is reliably anchored in position in the valve housing 29. In view of the difference in diameter between the first cylindrical portion 31 and the second cylindrical portion 32 of the valve housing 29, an annular channel 53 is formed between the tensioner housing 10 and the valve housing 29, said annular channel 53 allowing the hydraulic fluid to flow from the supply bores 27.1 and 27.2 to the inlet bores 39.1 and 39.2.

In the following, the operating mode of the above-described chain tensioner 7 will be explained in more detail. After the starting process of the internal combustion engine, pressure builds up in the system and hydraulic fluid flows via the supply bores 27.1 and 27.2 into the annular channel 53 and from there into the inlet bores 39.1 and 39.2. Due to the fact that the hydraulic pressure built up within the pressure chamber 22 has not yet reached a substantial level, the closure areas 43.1 and 43.2 bend inwards and uncover the inlet openings 40.1 and 40.2 so that hydraulic fluid will flow into the reception bore 33 and, via the cylindrical outlet bore 38, into the pressure chamber 22 until pressure balance occurs between the supply pressure and the pressure in the pressure chamber 22. The closure areas 43.1 and 43.2 then swing back and close the inlet openings 40.1 and 40.2 again. Such a chain tensioner 7 operates in a highly dynamic way and, when an internal combustion engine is in operation, the chain tensioner passes numerous oscillation states due load and speed changes. Damping is accomplished in the case of such chain tensioners 7 e.g. due to the fact that part of the hydraulic fluid flows off from the pressure chamber 22 through the leakage gap formed between the guided portion 18 of the tensioning piston 8 and the reception bore 16. When the tensioning piston 8 is to be extended again later on, the spring 23 forces the tensioning piston 8 outwards and hydraulic fluid flows in, thus compelling the non-return valve 28 to open once more. During retraction of the tensioning piston 8, the non-return valve 28 closes. A very high number of these processes recurs during operation in a highly dynamic manner, which means that the closure areas 43.1 and 43.2 are subjected to high alternating bending loads. In order to avoid excessive stress peaks, in particular in the holding area 42, the stop means 44 is provided, through which the opening stroke is limited. On the basis of the structural design of the non-return valve 28 shown, comparatively high flow rates of the hydraulic fluid can be accomplished even in the case of low opening pressures, since comparatively large opening cross-sections are provided, which are closed by only small moving masses.

It would also be imaginable to form a stamp-bending part that can be installed directly in the tensioner housing 10 without making use of an intermediate valve housing 29.

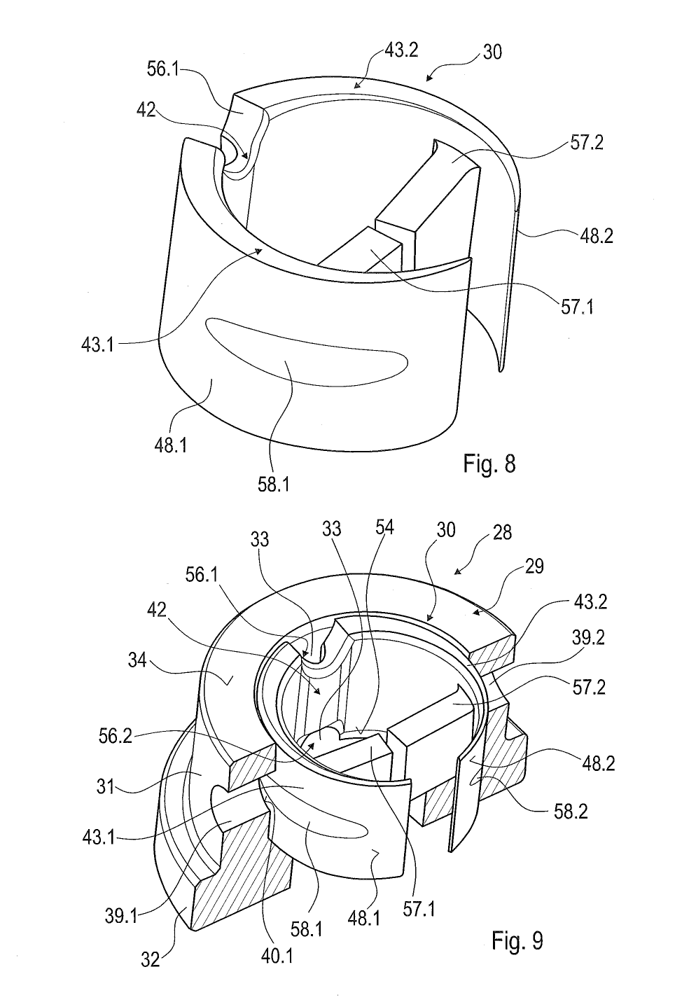

In the following, a further embodiment of a non-return valve 28 according to the present invention will be explained in more detail making reference to FIGS. 8 and 9. Only the essential differences will be discussed in the following, so that reference is additionally made to the above description.

The valve housing 29 is configured without a retaining groove 41 and has a differently configured reception bore 33. Said reception bore 33 has a larger first cylindrical portion and a smaller second cylindrical portion, so that a supporting step 54 is formed, which is provided with a centering projection 55 that is semicircular in cross-section in FIG. 9 and displaced relative to the two inlet bores 39 by substantially 90°. The valve housing 29 may be consist of a steel material or of some other metal or of plastic material.

The associated valve diaphragm 30 is, in the present case, not formed from a sheet metal blank, but produced as a plastic molding, which has preferably been produced by injection molding. Also a fiber-reinforced plastic material may here be used. For reasons of stability, the closure areas 43 are configured as continuous components, which do therefore not include any windows. In addition, the thickness of the closure areas 43 is much larger in the region following the holding area 42 than at the opposite free ends of the closure areas 43. As can be seen from the representation, the closure areas 43.1 and 43.2 decrease in thickness continuously. The holding area 42 is configured as a web projecting arcuately towards the interior of the valve diaphragm 30 and including a concave indentation 56.1, 56.2 at the upper end as well as at the lower end thereof. The lower concave indentation 56.2 is positioned, in a substantially accurately fitting manner, on the centering projection 55, whereby locking against rotation is accomplished. The stop means 44 is defined by two webs 57.1 and 57.2, which are arranged on the inner side of the closure areas 43 and the free end faces of which are spaced apart at a predetermined distance and determine the opening stroke limitation. On the outer side of the closure areas 43 a respective flow directing contour in the form of an oval, elongate depression 58.1 and 58.2 is provided, whose rear end begins on the level of inlet opening 40 and whose front end ends in spaced relationship with the free end of the closure areas 43. The pressure applied to the respective depressions 58.1 and 58.2 will thus also act on a front section of the closure areas 43, which is configured as a section of reduced thickness, whereby the closure areas 43.1 and 43.2 can be opened more easily.

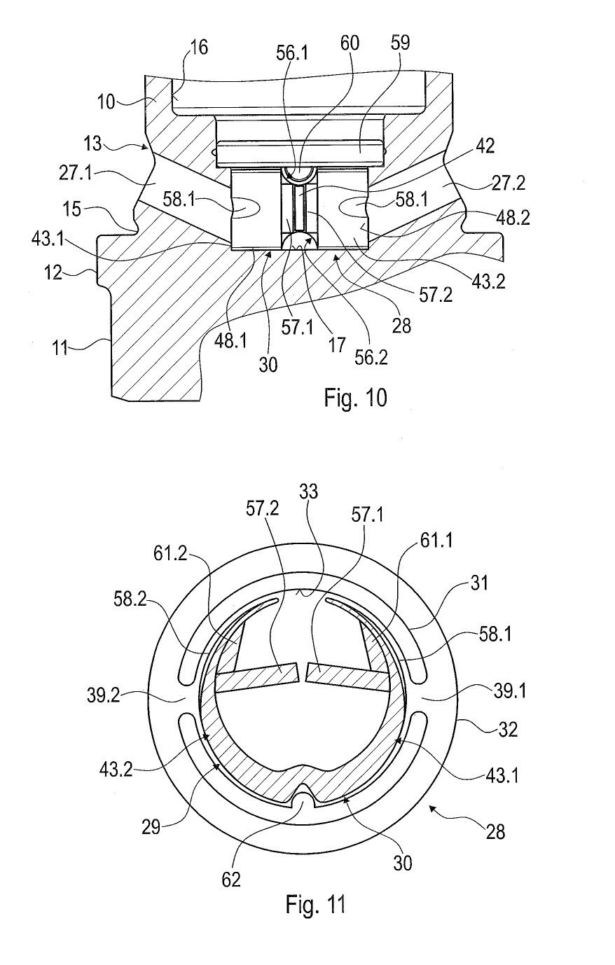

Making reference to FIG. 10, a further embodiment of the non-return valve 28 according to the present invention will now be explained in more detail. In this embodiment, the identical valve diaphragm 30 according to FIG. 8 is installed directly in the tensioner housing 10 of the chain tensioner 7. To this end, the lower area of the tensioner housing 10 has a slightly different structural design in comparison with the first embodiment. The two supply channels 27.1 and 27.2 are positioned on a slightly lower level and terminate slightly above the bottom surface 17. The valve diaphragm 30 is inserted in a bore section of the reception bore 16, whose height corresponds essentially to the height of the valve diaphragm 30. The reception bore 16 widens thereabove on the level of the supply portion 13 thus forming a first step having a retaining ring 59 press-fitted therein. The retaining ring 59 has on the lower side thereof a centering projection 60 engaging the upper recess 56.1 of the valve diaphragm 30 in a substantially accurately fitting manner and securing the valve diaphragm 30 thus against rotation relative to the retaining ring 59. Hydraulic fluid, which flows in through the inlet channels 27.1 and 27.2, flows past the closure areas 43 on the outer side thereof and into the interior of the non-return valve 28 and from there through the central opening of the retaining ring 59 upwards into the pressure chamber 22. The retaining ring 59 is positioned such that it does not impede the movement of the closure areas 43.

According to FIG. 11, a further embodiment of the non-return valve 28 according to the present invention will now be explained. In the following, only the essential differences existing in comparison with the preceding embodiment will be discussed, so that reference is additionally made to the above description.

The valve diaphragm 30 essentially resembles the valve diaphragm 30 according to FIG. 8. As can clearly be seen, reinforcement ribs 61.1 and 62.2 are provided as a variant on the webs 57.1 and 57.2 for stabilizing them as well as for stiffening the front portions of the closure areas 43.1 and 43.2. The valve housing is here made of plastic material and produced by means of injection molding. The section plane is on the level of the inlet bores 39.1 and 39.2. The lock against rotation is defined by a radially protruding projection 62, which engages the arcuately configured holding area 42 from behind.

The non-return valve 28 according to the present invention allows a cost-efficient and robust design.

1. A tensioning device, for a highly dynamic endless drive, or a chain drive or a belt drive for an internal combustion engine, comprising:
a tensioner housing, a tensioning piston displaceably arranged in the tensioner housing, a pressure chamber formed between the tensioner housing and the tensioning piston and a pressure medium inlet leading into the pressure chamber and including a non-return valve, a valve body of the non-return valve being defined by a spring diaphragm, wherein the spring diaphragm comprises a holding area, which is arranged such that it is at least secured against rotation preferably relative to the tensioner housing, and two elastically arranged closure areas extending away from said holding area in opposite directions and covering each a respective inlet opening in the closed condition, wherein a reception bore with a concave inner surface is provided, the inlet openings terminate at the concave inner surface, and the closure areas of the spring diaphragm have a curved shape, which is adapted to the reception bore, and abut on the concave inner surface of the reception bore in the closed condition, and a substantially central stop means is provided, which limits the opening stroke of the closure areas in common.

2. The tensioning device according to claim 1, wherein the reception bore is cylindrical in shape and the closure area has a curved shape adapted thereto.

3. The tensioning device according to claim 1, wherein the inlet opening and/or the reception bore is/are defined by the tensioner housing, and the spring diaphragm is installed directly in the tensioner housing.

4. The tensioning device according to claim 1, wherein the non-return valve includes a valve housing having the spring diaphragm arranged therein, and the valve housing is arranged in the pressure medium inlet.

5. The tensioning device according to claim 1, wherein an anti-loss and/or rotation-lock means retaining the spring diaphragm in any position is provided.

6. The tensioning device according to claim 1, wherein the spring diaphragm is produced from a stamp-bending part, preferably from a spring steel sheet.

7. The tensioning device according to claim 1, wherein the spring diaphragm is made of plastic material.

8. The tensioning device according to claim 1, wherein, starting from the holding area, the thickness of the closure area decreases substantially continuously towards the free end of the closure area.

9. The tensioning device according to claim 1, wherein the closure area has formed therein a flow directing contour in the form of a depression extending beyond the opening cross-section of the inlet opening.

10. A non-return valve for a tensioning device according to claim 1, wherein a valve body of the non-return valve is defined by a spring diaphragm.

11. An endless drive, in particular a timing drive of an internal combustion engine, comprising a drive pulley, at least one driven pulley, an endless drive means coupling said drive pulley and said driven pulley, and a tensioning device according to claim 1 for tensioning the endless drive means.
